(19) United States
(12) Patent Application Publication
(10) Pub. No.: US 2013/0215066 A1
(43) Pub. Date: Aug. 22, 2013

(54) APPLIANCE COMPRISING A DISPLAY AND OPERATING UNIT

(71) Applicants: Daniela Fertl, Munchen (DE); Fritjof Kaiser, Neubiberg (DE); Ines Steinke, Munchen (DE)

(72) Inventors: Daniela Fertl, Munchen (DE); Fritjof Kaiser, Neubiberg (DE); Ines Steinke, Munchen (DE)

(21) Appl. No.: 13/879,462

(22) PCT Filed: Oct. 14, 2011
(86) PCT No.: PCT/EP11/67977

§ 371 Date: Apr. 15, 2013

(30) Foreign Application Priority Data
Oct. 15, 2010 (DE) 10 2010 042 527.3

(51) Int. Cl. G06F 3/041

(52) U.S. Cl. CPC G06F 3/0412
USPC 345/173

(57) ABSTRACT

An appliance has four actuating elements are arranged around an edge of a display. One actuating element is arranged above the display, one below the display, one to the right of the display and one to the left of the display. In this way, the appliance is operated. A corresponding menu structure or list of applications on the display is coupled to the actuation of the actuating elements. A corresponding list in a hierarchy plane of the menu structure is run through or changed between applications running on the appliance by actuating the upper and lower actuating elements. The right and left actuating elements enable change from one hierarchy plane to another hierarchy plane of the menu structure or the display of detail information about applications. The appliance can especially be a portable appliance, e.g. an appliance that can be worn on the wrist or a mobile telephone.

### CROSS REFERENCE TO RELATED APPLICATIONS

This application is based on and hereby claims priority to International Application No. PCT/EP2011/067977 filed on Oct. 14, 2011 and German Application No. 10 2010 042 527.3 filed on Oct. 15, 2010, the contents of which are hereby incorporated by reference.

### BACKGROUND

The invention relates to an appliance comprising a display and operating unit.

Many different devices with a display and operating unit, such as, for example, laptops, mobile telephones, smartphones and the like, are known from the related art. Often, the devices are portable and thus suitable for mobile use. Use of the display and operating units of such devices should be intuitive to the user. It is also desirable for there to be a simple link between operation of the device and an associated display unit.

### SUMMARY

One possible object is therefore to create a device comprising a display and operating unit that can be operated simply and intuitively by a user.

The inventors propose a device comprising a display and operating unit. The display and operating unit comprises a display which, when arranged in the intended viewing position for a user, has a horizontal direction of extension for the display of lines of text as well as a vertical direction of extension in relation thereto. On the edge of the display, i.e. directly on or in the vicinity of the edge of the display, first through fourth actuating elements are provided, and are arranged in such a way that the first actuating element extends in a vertical direction above the display, the second actuating element extends in a vertical direction below the display, the third actuating element extends in a horizontal direction to the right of the display and the fourth actuating element extends in a horizontal direction to the left of the display or vice versa (i.e. the third actuating element extends to the left of the display and the fourth actuating element extends to the right of the display). If, for example, the display is embodied so as to be rectangular, arrangement above or below, and arrangement to the left or to the right, of the display, respectively correspond to arrangement on the upper or lower edge and to arrangement on the left or right edge of the display. One of the actuating elements is an interactive surface that can be actuated by a user to trigger actions by the device.

For the purposes, arrangement above or below the display means that when the actuating element is projected so as to extend in a vertical direction onto the edge of the display there is an overlap between the actuating element and the edge. In the same way, arrangement to the left or the right of the display means that when the actuating element is projected so as to extend in a horizontal direction onto the edge of the display there is an overlap between the actuating element and the edge of the display. It should be borne in mind here that the third and fourth actuating elements extending in a vertical direction are always arranged between the first and second actuating elements.

If the display is embodied as a circle, arrangement above or below the display, and arrangement to the left or to the right, preferably correspond to the following arrangement: The circle is divided into sectors with 90° sector angles, one upper sector being defined by the fact that it extends upward symmetrically around the vertical axis running through the center of the circle. The sector next to that upper sector in a clockwise direction is the right sector, which is followed by the lower sector and the left sector. If the actuating element is located in the upper sector, the actuating element is arranged above the display. If the actuating element is located in the right sector, the actuating element is arranged to the right of the display. If the actuating element is located in the lower sector, the actuating element is arranged below the display. If the actuating element is located in the left sector, the actuating element is arranged to the left of the display.

The proposed device is characterized in that the display can be operated in one or more display modes in which entries on a list on one hierarchy plane in a menu structure and/or applications executed by the device are activated on the display. Actuation of the first actuating element causes the list to change between activated list entries and/or applications in a predetermined order and actuation of the second actuating element causes the list to change between activated list entries and/or applications in the opposite order to the predetermined order. Also, actuation of the third actuating element changes the view to another view with information on the activated list entry and/or the activated application, it being possible to exit this other view by actuating the fourth actuating element.

For the purposes, list entries are appropriate terms or symbols for describing the underlying menu tree. Applications, on the other hand, correspond to programs that can be executed on the device. Also, these applications can, if necessary, be linked to applications on other devices, so that an application can also control other devices or units. A list entry can also refer to an application that can be called for the activated list entry through actuation of another actuating element. The phrase “activation of a list entry” should be understood as meaning the display, or selection, of the list entry on the display. “Activation of an application on the display” should be understood as meaning the display of the corresponding application on the display, it being possible either for the application to have already been executed beforehand or for it only to be started upon activation.

The device is characterized by intuitive, easy-to-understand navigation by corresponding actuating elements arranged around the display. The first and second actuating elements make scrolling between list entries or applications possible, whereas the third and fourth actuating elements are respectively used to display the context of the list entries or applications in the form of another view, and to exit the context.

In a particularly preferred embodiment the display mode or modes of the device include a first display mode, in which the list entries on the display are activated, it being possible to change to a list on the next hierarchy plane down in the menu structure (if such a plane exists) by actuating the third actuating element. This display of the next hierarchy plane down corresponds to the other view described above. It is also possible to change to the next hierarchy plane up in the menu structure (if such a plane exists) by actuating the fourth actuating element.

In a further embodiment the first display mode is configured in such a way that, in the event that the activated list entry refers to an application executed by the device, the corresponding application as referred to on the display is activated through actuation of the third actuating element. In another variant, the first display mode is configured in such a way that a predetermined application is activated on the display through actuation of the fourth actuating element if a list entry on the list on the uppermost hierarchy plane in the menu structure was activated before the fourth actuating element was actuated. The predetermined application is preferably an application with a high priority in the device, for example, an application by which the time and/or the date is displayed.

In another particularly preferred embodiment of the device, and as an alternative to or in addition to the first display mode, a second display mode is provided in which applications are activated on the display and detailed information on the activated application is displayed as another view through actuation of the third actuating element. The second display mode is preferably configured in such a way that no application other than the activated application is displayed, thus ensuring that a large part of the display is available for the activated application.

In another particularly preferred embodiment the second display mode is configured in such a way that by actuating the fourth actuating element it is possible to change from an application that is activated on the display to a predetermined application by activating the predetermined application on the display. This makes it possible for a predetermined application with high priority such as, for example, the abovementioned time and/or date display, to be called quickly.

In another particularly preferred embodiment the first through fourth actuating elements are arranged around the edge of the display in such a way that the entire edge of the display is surrounded by these actuating elements. As a result, a device can be produced with compact dimensions.

In one particularly preferred embodiment the display is embodied so as to be rectangular and, when the display is in the viewing position, the first actuating element extends along the entire upper edge of the display, the second actuating element extends along the entire lower edge of the display, one out of the third and fourth actuating elements extends along the entire right edge of the display and the other of the third and fourth actuating elements extends along the entire left edge of the display. As a result, corresponding directions of navigation—upward and downward or to the left or right—are conveyed particularly intuitively by the arrangement of the actuating elements.

A particularly easy to understand way of conveying direction of navigation is also achieved in another embodiment in which each of the first through fourth actuating elements has an actuating surface that is essentially arranged on the plane of or parallel to the plane of the display, with the directions of navigation preferably also being indicated by arrows on the actuating surfaces.

As well as being operable in the display modes described above, the device can also, if necessary, be operated in one or more other display modes in which input from the user is requested that is based on the actuation of appropriate actuating elements from among the first through fourth actuating elements.

In one particularly preferred embodiment of the device it is also possible for one or more of the display modes of the device to be configurable by the user. In particular, it is possible, via the first or second actuating element, conveniently to specify applications for the second display mode.

In another embodiment of the device a fifth actuating element is provided, in addition to the first through fourth actuating elements, with which a display mode, and in particular the first display mode described above, can be called and with which it is possible to change between display modes.

In addition or as an alternative to the fifth actuating element a sixth actuating element can be provided with which an emergency call and/or alarm function can be activated. Such a sixth actuating element can, for example, be incorporated into the device when it is implemented as a watch or mobile telephone for seniors. In an emergency (e.g. health-related) the user, who is likely to be an elderly or sick person, can then, by actuating the sixth actuating element, transmit an emergency call or an alarm to a central control center via an appropriate communications interface, in particular a mobile communications interface, which can then locate the device, and thus the user, and send medical assistance to the location of the user.

The first through fourth actuating elements, as well as, in particular, the fifth and sixth actuating elements described above, can be implemented on the basis of any desired technologies known from the related art. In particular, the actuating elements can be implemented as mechanically actuatable elements (e.g. buttons or switches) and/or as touch-sensitive sensors. In a preferred variant the sixth actuating element comprises both a mechanically actuatable element and a touch-sensitive sensor, which is embodied on the surface of the element. In such cases the emergency call function is only actuated if the element is mechanically actuated and contact between the sensor and human skin is also detected. This helps avoid incorrect actuation of the emergency call or alarm functions. Possible technologies for a touch-sensitive sensor include, for example, the detection of contact via the resistance of human skin, also known as touch-screen. Also, where appropriate, the first through fourth actuating elements need not be implemented as separate components but can be implemented in the form of predetermined areas on the edge of the display that comprise only the function of the corresponding actuating element.

In a particularly preferred embodiment, the device is a mobile device, in particular a wristband device of the wristwatch type, and/or a mobile telephone. In the embodiment as a wristwatch device, or wristwatch, a central display and operating unit is provided that is mounted in very local and favorable place for the user within their immediate reach on their wrist.

The applications that can be executed on the device can be configured in various ways, depending on the area of use. For example, one or more of the following applications are executable on the device:

An application for displaying the time and/or the date;

A calendar for managing appointments;

An address book for managing contacts;

An application for telephoning and/or exchanging data via a mobile communications connection;

An application for monitoring vital functions of the human body.

In the last-named application the vital functions are recorded by corresponding sensors on the body of the user, with the sensor values being transmitted via a suitable interface, in particular a non-contact interface.

The device can also be used in other, technical fields of application. In particular, the device can be a control unit for a building or for an automation system or for an energy-producing and/or energy-distributing system.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a perspective drawing of an exemplary embodiment in the form of a wristwatch in a first display mode;

FIG. 2 is a perspective drawing of the wristwatch in FIG. 1 in a second display mode; and

FIG. 3 is a schematic diagram showing selection of applications in second display mode.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

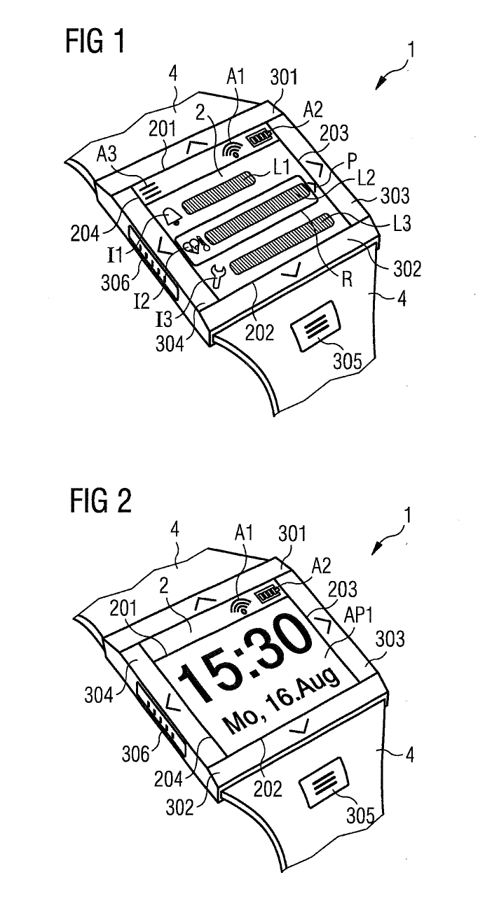

In the following, an embodiment of the device is described through the example of a multifunctional wristwatch, a perspective view of which is shown in FIG. 1, where it is identified by the reference sign 1. The wristwatch in FIG. 1 comprises a central rectangular display 2 that can, for example, be embodied as an OLED display. Around and on the plane of the display are arranged corresponding actuating elements in the form of touch-sensitive sensors that completely surround the display. A first actuating element 301 extends along the upper edge 201 of the display, a second actuating element 302 extends along the lower edge 202 of the display, a third actuating element 303 extends along the right edge 203 of the display and a fourth actuating element 304 extends along the left edge 204 of the display. In this arrangement, actuating elements 303 and 304 are exactly the same length as the corresponding edges 203 and 204, whereas actuating elements 301 and 302 extend across and beyond edges 201 and 202 to the outer limits of actuating elements 303 and 304 respectively.

As already mentioned, the actuating elements are implemented as touch-sensitive sensors, it being possible, by measuring the resistance of human skin, to record its contact with the corresponding actuating element, as a result of which a corresponding action is triggered. Where appropriate, other technological implementations of touch-sensitive sensors, in particular those using touch-screen technology (e.g. acoustic pulse recognition or Carroll touch infrared technology) can also be used. It is also possible for the display 2 to be embodied so as to be larger and thus also comprise the areas of actuating elements 301 through 304, it being possible for the functionality of the display in these areas to then correspond to the functionality of a corresponding actuating element. This means that the actuating element is actuated by the area of the display being touched that corresponds to the area of the corresponding actuating element in FIG. 1.

Attached to the upper or lower actuating element 301 or 302 respectively is a corresponding wristband 4 with which the watch can be fastened to the wrist of a user. Another actuating element 305 in the form of a menu button which, similarly to the first through fourth actuating elements, can be embodied as a non-contact sensor and serves to change the display modes described in more detail below, is implemented in the lower part of the wristband. The watch in FIG. 1 also comprises, on the left side, another actuating element 306 that is configured as a combination of a mechanically actuated button and a touch-sensitive sensor. In the embodiment in FIG. 1 the actuating element 306 serves as an emergency button and, in the event of an emergency such as, for example, an acute health problem of the user, enables activation of an emergency call to a central control center, it only being possible for such an emergency call to be triggered if the button is operated by mechanical depression and the touch-sensitive sensor records that human skin has come into contact with the surface of the actuating element 306. In the embodiment in FIG. 1 the surface of the actuating element 306 is haptically enhanced by small raised sections so that a user can find the actuating element quickly in an emergency situation.

The wristwatch in FIG. 1 is thus of particular use to people with health problems, as it enables them to make an emergency call quickly using the actuating element 306. The watch has an appropriate communications interface, preferably a mobile communications interface with which, upon actuation of the actuating element 306, a medical control center is informed which can then locate the position of the watch and thus of the person. This location can be achieved using known technologies such as, for example, GPS or localization of the mobile radio cell in which the wristwatch is located.

Via the actuating elements 301 through 304 it is possible simply and intuitively to make use of the corresponding functions of the watch. Two display modes have been implemented, it being possible for the display in FIG. 1 to display a snapshot of the first display mode. In addition to displays that are specific to the display mode the display also contains symbols that are displayed in all the display modes. In the case of the watch in FIG. 1 these are the symbols A1 and A2, the symbol A1 indicating the strength of the network reception of a mobile network and the symbol A2 indicating the charge status of the battery of the wristwatch. A symbol A3 indicated by three vertical lines is also displayed in the upper left corner of the display and conveys the fact that the display is in first display mode.

In first display mode, the menu structure of the functionalities implemented in the wristwatch is made visible. The menu structure in this case is a menu tree of branching menu items on different hierarchy planes, with the menu items on one hierarchy plane being displayed in corresponding lists that can be run through in first display mode via the actuating elements 301 or 302. The list includes the child nodes that correspond to any parent node of the menu tree that branches onto a deeper hierarchy plane.

The drawing in FIG. 1 shows, by way of example, three menu items, or list entries—L1, L2 and L3—which are shaded. List entry L1 corresponds to the text “Appointments”, list entry L2 to the text “Home visits” and list entry L3 to the text “Settings”. For the purposes of more rapid understanding of the content of the respective list entries, corresponding icons II, I2 and I3 are provided: icon I1 represents a bell, icon I2 represents a heart and a thermometer and icon I3 a wrench tool. List entry L1 conveys to the user that the menu tree, starting with this list entry, leads to applications relating to appointments, such as, for example, a calendar. List entry L2 conveys that the menu tree, starting with this list entry, leads to applications relating to the monitoring of vital functions of the user of the wristwatch. Entry L3 conveys that the menu tree leads from this list entry to applications that relate to settings of the wristwatch. The menu trees extending further to the right starting from list entries L1 to L3 can be embodied in a variety of ways, depending on the embodiment of the wristwatch. For example, the “Home visits” menu tree can lead to a number of different vital monitoring functions, such as measurement of the pulse, blood pressure and body temperature of the user. The user carries sensors on their body, with which the corresponding bodily functions are recorded and transmitted wirelessly to the wristwatch.

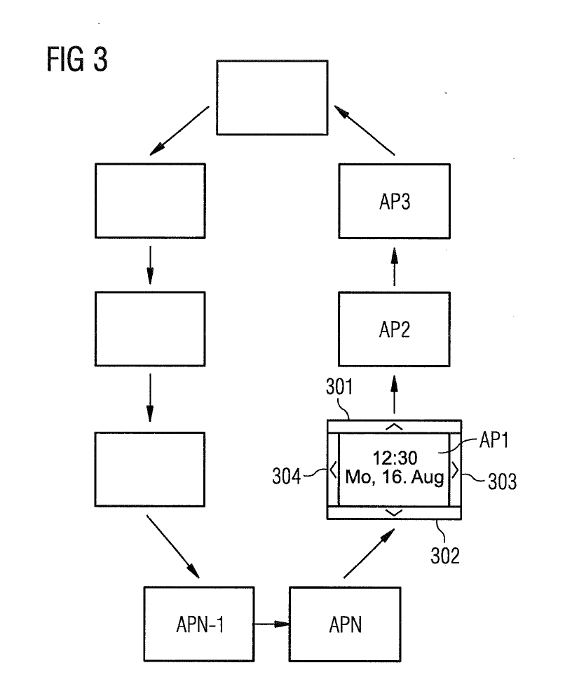

The list indicated in FIG. 1, which displays the list entries L1 to L3, is a rotating band of list entries, it only being possible for three list entries from the band to be displayed on the display. Actuation of the actuating element 301 causes virtual representations of upstream entries on the band to become visible on the display 2, whereas actuation of the lower actuating element 302 causes virtual representations of downstream entries on the band to become visible on the display 2. In terms of its functionality, the rotating band of lists corresponds to the rotating band of applications described below, which is illustrated by FIG. 3.

When display 2 is in first display mode a list entry is always activated, and in the embodiment described here the activated entry is always the entry that has just been displayed, this being indicated by the entry being highlighted in color and surrounded by a frame R. In addition, an arrow P on the right next to the frame R conveys that, via the activated entry, it is possible to change to lower hierarchy planes on the menu tree that leads from this entry. It is possible to change to lower hierarchy planes by actuating the actuating element 303 and to go back to higher hierarchy planes on the menu tree by actuating the actuating element 304. Moving to lower hierarchy planes takes the user to further lists, with the menu tree normally ending in one or more list entries in the form of references to applications. The corresponding application can then be shown on the display by activating the list entry that refers to the application and depressing the actuating element 303.

The menu button 305 of the wristwatch in FIG. 1 serves to change to first display mode if the watch is in another display mode and in particular in the second display mode described below. If the menu button 305 is depressed in the display mode shown in FIG. 1 this results in a predetermined application being displayed on the display of the wristwatch. In such cases, this application is preferably the time and date display as shown in FIG. 2 described below. The change to the predetermined application also means that the watch is now in second display mode, meaning that it is possible to change between the first and second display modes. If the list shown in the first display mode is in the highest hierarchy plane of the menu tree it is also possible to change to the predetermined application, and thus to second display mode, by actuating the actuating element 304.

The first display mode described with the aid of FIG. 1 provides simple and intuitive navigation to a corresponding menu tree via the actuating elements 301 through 304 arranged around the display. Arrows on the surfaces of the actuating elements indicate the corresponding left, right, upward and downward directions of navigation. Navigating to the right means changing to a lower hierarchy plane and navigating to the left means changing to a higher hierarchy plane. Navigation in the upward or downward directions, however, is achieved by scrolling accordingly through a list on the same hierarchy plane of the menu structure. Also, the first display mode can easily be called and hidden again via menu button 305. It is also possible, if necessary, flexibly to adapt the individual menu entries to various user-specific fields of application via a configuration in a corresponding configuration program of the watch.

FIG. 2 shows the wristwatch of FIG. 1 with the second display mode selected. The individual components of the wristwatch already described with the aid of FIG. 1 are not illustrated again here. In the second display mode shown in FIG. 2 there is no changing between individual lists in a menu structure but between different applications that can be run on the wristwatch. As already mentioned above, the applications are displayed on a rolling band of quickly callable views, referred to below as “quickviews”. In FIG. 2, the application displayed is AP1, which corresponds to the display of the time (15:30 h) and the date (Monday 16 August). This application is the predetermined application already mentioned above, to which it is possible to change in first display mode by actuating the menu button 305 or, in certain constellations, by actuating the actuating element 304. Also, not shown in the display mode shown in FIG. 2 is the symbol A3 via which it is conveyed to the user that they are not in the menu display of the first display mode but in the display of the rotating applications of the second display mode.

The concept of rotating quickviews is shown in further detail in FIG. 3. The display with the four actuating elements 301 through 304 is represented schematically, with the predetermined application AP1 in the form of the time and date display shown on the display. The predetermined application here is an application with high priority on a band on which a succession of related applications is listed, the applications being represented by corresponding rectangles. By way of example, two applications located upstream from application AP1 are identified by the reference signs AP2 and AP3 and the first and second applications downstream from application AP1 are identified by the reference signs APN and APN−1. The applications in the direction of the arrows represented are run through by actuating the upper actuating element 301, i.e. application AP2 is called first by touching the actuating element 301, followed by application AP3 when the actuating element 301 is next touched, and so on, until application APN is called. Similarly, in the opposite direction, the applications from AP1 to APN, APN−1, etc., starting with AP1, can also be run through by touching the actuating element 302 in each case. It is thus possible, through appropriate selection via actuating elements 301 and 302, quickly to navigate backwards and forwards between any desired applications. It is also possible to display detailed information on a displayed application by actuating the actuating element 303, after which it is possible to navigate back to the application by actuating the actuating element 304.

The rotating band of applications shown can be suitably configured, or suitably preconfigured, by a user, the application with the highest priority in the diagram in FIG. 3 being the time and date display AP1, and applications with the next highest priorities being arranged immediately upstream or immediately downstream from application AP1 on the rotating band of applications. This means that, in FIG. 3, the applications with a high priority are applications AP2 and APN, which can be called with a single actuation of the corresponding actuating element, whereas several actuations are required to call the applications immediately upstream or downstream, which have lower priorities.

Some of the various applications implemented in the wristwatches in FIG. 1 and FIG. 2 also contain user dialogs, with which a relevant instruction is requested from the user via a prompt on the display 2. The particular manner in which the actuating elements are arranged around the display 2 enables very intuitive user dialogs such as a binary request to be implemented. For example, a question such as “Delete data?” can be placed in the middle of the display, after which the user can be requested to answer “Yes” or “No”, via actuating element 301 or 302 respectively.

As stated above, the individual actuating elements 301 through 304 of the wristwatch 1 are embodied as touch-sensitive sensor surfaces that can be implemented on the basis of various technologies. For example contact with, and thus actuation of, the actuating element can be detected via the sensor surfaces through measurement of skin resistance. This protects against undesired operation of the wristwatch, for example as a result of contact with objects such as the user's clothing. It is, however, also possible, where appropriate, for the individual actuating elements to be embodied not as touch-sensitive sensors but, for example, as mechanically actuatable buttons.

It is also possible for the wristwatch in FIG. 1 to have an integral lock function for locking the watch against unintended actuations of the actuating elements. Locking of actuating elements 301 through 305 is preferably achieved by a user simultaneously actuating the upper and lower actuating elements 301 and 302. Actuating element 306 is excluded from the locking process so that an emergency call can be activated even when the lock function is activated. The lock function can be reversed in the same way as it is activated, through simultaneous actuation of actuating elements 301 and 302.

The embodiment described above has a number of advantages—in particular, the technology of having actuating elements arranged around the display in a way that is optimal for navigation, and thus for intuitive interactive operation of the display. The display is surrounded by four separate actuating elements for navigating to the left, the right, upward and downward. Each of the actuating elements occupies an entire horizontal or vertical area around the display. The consequent high-performance implementation technology of the actuating elements, in particular that based on touch-sensitive sensor surfaces, makes fast navigation possible because the desired information is displayed quickly.

The embodiment described above was illustrated using a wristwatch as an example. The inventors' proposals can, however, also be used on other devices, in particular other portable devices such as, for example, mobile telephones. The inventors' proposals can also be used in other technical fields, it being possible, for example, for the display described, together with the actuating elements arranged around it, to be used in connection with a display and control field of a control device for a building or for an automation system for production or process automation, or for an electrical energy-producing or energy-distributing system.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-18. (canceled)

19. A device comprising:
a display, which when arranged in a viewing position for a user, has a horizontal direction and a vertical direction, the display having an edge and left and right sides, the display displaying lines of text extending in the horizontal direction, the display comprising at least first and second display modes, the first display mode displaying a list of entries, the second display mode displaying information on one entry from the list of entries; and
an operating unit comprising first, second, third and fourth actuating elements provided at an edge of the display, the first actuating element extending in the vertical direction above the display, the second actuating element extending in the vertical direction below the display, the third actuating element extending in the horizontal direction on the right or left side of the display and the fourth actuating element extending in the horizontal direction on the left or right side of the display opposite the third actuating element, wherein
actuation of the first actuating element causes the list to change between activated list entries and/or applications in a predetermined order,
actuation of the second actuating element causes the list to change between activated list entries and/or applications in an order opposite to the predetermined order;
actuation of the third actuating element changes to the second display mode, and
actuation of the fourth actuating element changes to the first display mode.

20. The device as claimed in claim 19, wherein
the first and second display modes are part of a hierarchical menu structure,
actuation of the third actuation element changes to a display mode one hierarchy plane lower in the menu structure, and
actuation of the fourth actuating element changes to a display mode one hierarchy plane higher in the menu structure.

21. The device as claimed in claim 20, wherein
the hierarchical menu structure comprises at least three display modes,
an upper display mode displays a list of function groups,
a middle display mode displays a list of applications related to one of the function groups, and
a lower display mode displays information on one application from the list of applications.

22. The device as claimed in claim 20, wherein
the first display mode displays a list of potential applications, one of the potential applications being visually offset in the list, and
actuation of the third actuation element causes the device to execute the potential application that is visually offset in the list.

23. The device as claimed in claim 22, wherein
in the first display mode, the first and second actuating elements scroll through the list of potential applications in reverse directions so as to change the application that is visually offset in the list.

24. A method as claimed in claim 20, wherein
the second display mode displays information on a predetermined application,
the first display mode displays a list of potential applications, and
actuation of the fourth actuating element switches to the first display mode in which the predetermined application is visually offset in the list of potential applications.

25. The device as claimed in claim 19, wherein
in the second display mode, a predetermined application is executed, and
detailed information on the predetermined application is displayed in the second display mode.

26. The device as claimed in claim 25, wherein the second display mode displays information on only the predetermined application.

27. The device according to claim 19, wherein the first through fourth actuating elements are arranged around the edge of the display such that the edge of the display is entirely surrounded by the actuating elements.

28. The device according to claim 19, wherein
the display is rectangular, and
when the display is in the viewing position, the first actuating element extends along an entire upper edge of the display, the second actuating element extends along an entire lower edge of the display, one actuating element out of the third and fourth actuating elements extends along an entire right edge of the display and another actuating element out of the third and fourth actuating elements extends along an entire left edge of the display.

29. The device as claimed in claim 19, wherein each of the first through fourth actuating elements has an actuating surface that is essentially arranged on a plane of the display or on a plane parallel to the plane of the display.

30. The device as claimed in claim 19, wherein
the display comprises a third display mode separate from the first and second display modes, and
in the third display mode, the device requests input from a user based on actuation of appropriate actuating elements from among the first through fourth actuating elements.

31. The device as claimed in claim 19, wherein the display comprises at least one display mode which is configurable by a user.

32. The device as claimed in claim 19, further comprising a fifth actuating element with which a predetermined display mode is called.

33. The device as claimed in claim 32, wherein the fifth actuating element activates the predetermined display mode only when the fifth actuating element is being actuated.

34. The device as claimed in claim 19, further comprising a sixth actuating element to activate an emergency call and/or alarm function.

35. The device as claimed in claim 19, wherein at least one of the actuating elements is mechanically actuatable and/or comprises a touch-sensitive sensor.

36. The device as claimed in claim 19, wherein at least one of the actuating elements is actuated only if a mechanical force is received while a touch-sensitive sensor senses operator touch.

37. The device as claimed in claim 19, wherein the device is a wristband device and/or a mobile telephone.

38. The device as claimed in claim 19, wherein
the first and second display modes execute a plurality of applications on the device, and
the plurality of applications comprises at least one application selected from the group consisting of:
an application for displaying time and/or date;
a calendar for managing appointments;
an address book for managing contacts;
an application for telephoning and/or exchanging data via a mobile communications connection; and
an application for monitoring vital functions of a human body.

39. The device as claimed in claim 19, wherein the device is a control unit for a building, an automation system, an energy-producing system and/or an energy-distributing system.
